(19) United States
(12) Patent Application Publication
(10) Pub. No.: US 2007/0164856 A1
(43) Pub. Date: Jul. 19, 2007

(54) Processing gesture signals

(75) Inventors: Sebastian Egner, Eindhoven (NL); Kero Van Gelder, Eindhoven (NL); Fabio Vignoli, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.V.,a corporation, Eindhoven (NL)

(21) Appl. No.: 10/577,299

(22) PCT Filed: Oct. 20, 2004
(86) PCT No.: PCT/IB04/52155

§ 371 Date: Apr. 27, 2006

(30) Foreign Application Priority Data
Oct. 27, 2003 (EP) 03103966.2

(51) Int. Cl. G08B 1/08

(52) U.S. Cl. 340/539.13

(57) ABSTRACT

A method of pre-processing gesture signals comprises the step of Filtering one or more signal segments by applying an infinite impulse response (IIR) filter both in a forward and in a backward temporal direction, so as to produce a band-limited gesture signal. The method may further comprise the step of matching the forward and backward initial conditions of the IIR filters to avoid any transients. Unevenly or sparsely sampled gesture signals may be subjected to the preliminary steps of interpolating the sampled signal, resampling the interpolated signal at a relatively high resampling frequency, filtering the resampled signal, and optionally downsampling the filtered signal, so as to produce a gesture signal having a well-defined sampling rate. An additional compression step may be carried out. The method may be utilized in conjunction with handwriting recognition methods.

The present invention relates to a method of processing a gesture signal. In addition, the invention relates to a software program for carrying out the method and to a data carrier comprising such program. The invention further relates to a device for processing gesture signals and to a handwriting recognition system.

The present invention can be used for processing gesture signals that are obtained from low quality acquisition devices such as a PC mouse, a finger or pen on a touch screen or a light pointer on a wall. A method for processing gesture signals is presented in “The DataPaper: living in the Virtual World” by Mark Green and Chris Shaw (Proceedings of Graphics Interface '90, pages 123-130, Halifax, Nova-Scotia, May 1990 of the Canadian Human Computer Communication Society). Green and Shaw disclose a method wherein a gesture signal obtained from a data glove is filtered by means of a FIR filter in order to suppress undesired signal components.

It is an object of the present invention to provide an improved method for processing gesture signals. This object is according to the present invention realized in that the method of processing a gesture signal that is having one or more segments, is comprising the step of filtering one or more segments by applying an infinite impulse response filter both in a forward and in a backward temporal direction, so as to produce a band-limited gesture signal.

The invention is based upon the insight that the computational complexity of IIR filters is less than FIR filters. Therefore it is possible to meet the required stop-band attenuation and transition-band requirements with far less taps compared to a FIR filter. The invention is further based upon the insight that IIR filters may introduce non-linear phase errors to the processed gesture signal which, according to the invention, can be cancelled out IIR filtering the gesture signal in the time domain in both the forward and backward direction.

In another embodiment according to the present invention, the method is further comprising the preliminary steps of:
interpolating the gesture signal, and
resampling the gesture signal,

so as to produce a gesture signal having a well-defined sampling rate. Gesture signals may be sparsely and unevenly sampled signal. If unevenly sampled signals were treated as if they were evenly sampled, any results derived from these samples would be severely distorted. On the other hand, sparsely sampled gesture signals are generally considered unsuitable for further processing. By interpolating a sparsely sampled signal, it is possible to derive additional signal values in the resampling, step. These additional samples can be evenly spaced, even if the original samples were not evenly spaced. When the resampling is carried out at a relatively high frequency, a sufficient number of samples can be obtained, even if the original samples were sparsely sampled.

In an embodiment according to the present invention, the step of interpolating the gesture signal involves a linear interpolation. Linear interpolation is a relatively simple and numerically stable method, which allows additional samples to be easily derived during the resampling step.

In another embodiment according to the present invention, the method is further comprising a down sampling of the filtered signal so as to satisfy Shannon's criteria and thus to prevent aliasing.

In an embodiment according to the present invention, the method is further comprising the step of compressing the signal which, is advantageous for storage and transmission of the gesture signals. The step of compressing the signal can be carried out with various source coding technique such as differential coding or entropy encoding.

The present invention further provides a software program for carrying out the method according to any of the preceding claims, as well as a data carrier comprising the software program. The present invention additionally provides a device and a system for processing gesture signals. The device may incorporate the software program mentioned above. Alternatively, or additionally, the device according to the present invention may be arranged for processing a gesture signal comprising one or more segments, each segments comprising one or more samples, the device comprising means for filtering one or more segments by applying an infinite impulse response filter both in a forward and in a backward temporal direction, so as to produce a band-limited gesture signal.

The present invention will further be explained below with reference to exemplary embodiments illustrated in the accompanying drawings, in which:

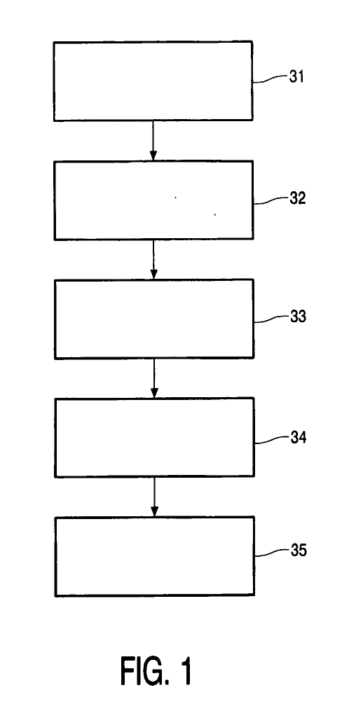

FIG. 1 schematically shows a preferred embodiment of the filtering method of the present invention.

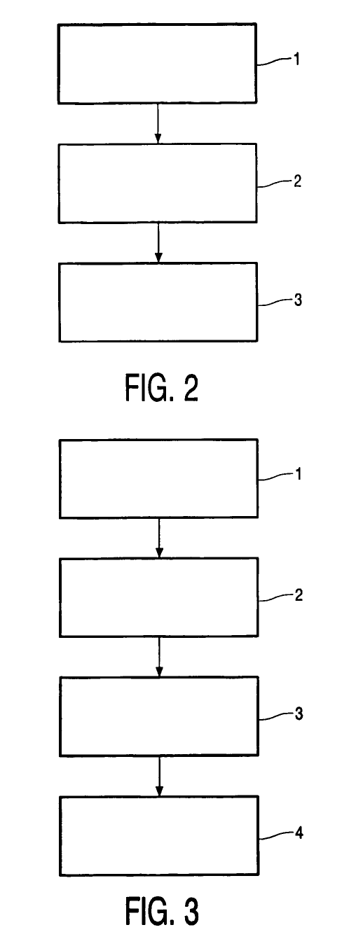

FIG. 2 schematically shows a first embodiment of the signal processing method of the present invention incorporating the filtering method.

FIG. 3 schematically shows a second embodiment of the signal processing method of the present invention.

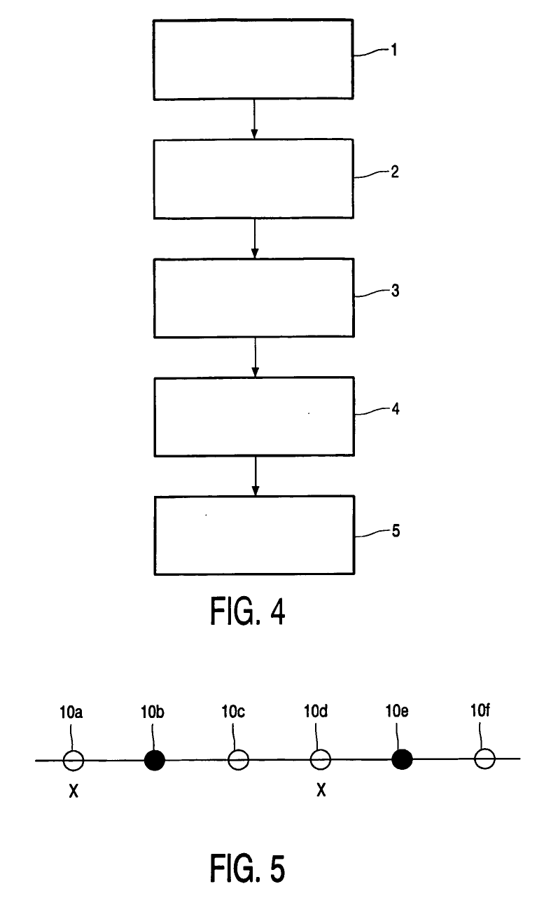

FIG. 4 schematically shows a third embodiment of the signal processing method of the present invention.

FIG. 5 schematically shows a down sampling process as may be used in the present invention.

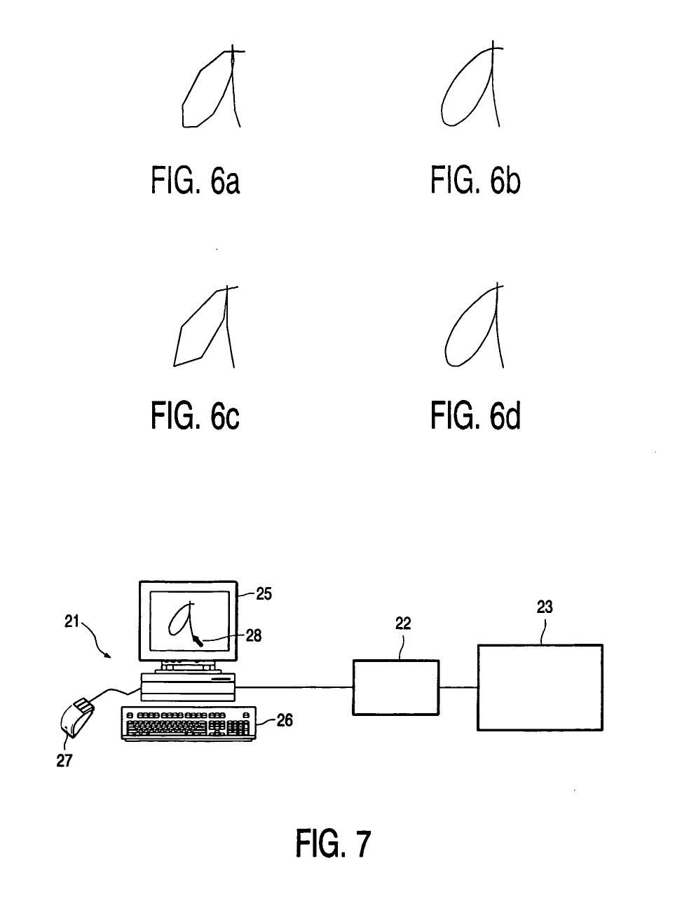

FIGS. 6a-d schematically show examples of handwriting as processed in accordance with the present invention.

FIG. 7 schematically shows a gesture signal processing system according to the present invention.

A gesture signal filtering method in accordance with the present invention is illustrated merely by way of non-limiting example in FIG. 1. The filtering method as presented in FIG. 1 may be part of a signal processing method involving additional steps. In particular, the filtering method of FIG. 1 may constitute the filtering step 3 of FIGS. 2-4.

The filtering method illustrated in FIG. 1 comprises steps 31-35. Step 32 involves using an IIR filter known per se to forward filter the gesture signal. In step 34, the gesture signal is backward filtered using an IIR filter. The forward and backward IIR filters may be identical. However, separate forward and backward IIR filters may also be used. The temporal order of the samples is reversed in steps 33 and 35. By reversing the sample order and having one forward and one backward filtering operation, a zero-phase filtering operation is obtained. It will be apparent to those skilled in the art, that the filtering of the gesture signals should preserve as much as the length of the gesture segment, since particularly the begin and end-points of a gesture segment comprises much information. An incorrect application of the filter may therefore result in a loss of information and causes “gaps” at the end points of the gesture segments. It will be apparent to those skilled in the art that these gaps may give rise to the well known “missing end point problem” and should therefore be avoided.

In accordance with the present invention the initial conditions of the forward and backward filters are matched in step 31. It is noted that this matching step precedes the filtering steps. As will be recognized by those skilled in the art, recursive or IIR filters have an initial state which influences the result of the filtering. To avoid any transients, the present invention proposes to set those initial states prior to applying the filters. In a first embodiment, the initial states are set to zero. In a second embodiment, the initial conditions are matched: it is attempted to make the initial conditions of the backward filter identical to the initial conditions of the forward filter. Preferably, this is accomplished using the well-known least squares technique as is for example discussed in an article by Fredrik Gustafsson, Determining the Initial States in Forward-Backward Filtering, IEEE Transactions on Signal Processing, Vol. 44, No. 4, Apr.1996.

The steps 31-35 are preferably implemented in software, that is, in a software program capable of running on a suitable computer. Alternatively, some or all steps 31-35 may be implemented in dedicated hardware. It will be appreciated by those skilled in the art that the order of the filtering steps as shown in FIG. 1 may be altered and need not necessarily correspond to the sequence as shown. A sequence comprising the steps 31-33-32-35-34 for example would also be possible in order to reverse the samples before each IIR filtering step. Alternatively, the reversing steps 33 and 35 could be made part of filtering steps 32 and 34.

The signal processing method in accordance with the present invention shown merely by way of non-limiting example in FIG. 2 comprises a number of steps. It is assumed that a gesture signal is available in the form of a series of digital samples, each sample comprising e.g. a pair of coordinates x, y and a time reference t. The samples of the original, unprocessed gesture signal will be referred to as original samples. It is further assumed that the original gesture signal is unevenly and/or sparsely sampled. However, for a successful processing of the gesture signals, the signals are preferably sampled with a sampling rate above 60 Hz.

However, the method described below may also be applied to signals which are not unevenly and/or sparsely sampled.

In an interpolation step 1 the original samples are interpolated, this can be done by, but it is not limited to, a linear function.

In a resampling step 2 the number of samples is increased by adding samples on the basis of the interpolation of step 1 to form an augmented set of samples. New samples are produced by calculating the coordinates x, y at chosen times t using the mathematical functions of step 1. The time intervals between these chosen points in time determine the sampling frequency (or resampling frequency) of the augmented set of samples. These time intervals are preferably all of the same duration to provide an even (re)sampling. A particularly suitable time interval is 50 ms, which corresponds with a (re)sampling frequency of 200 Hz. Other time intervals and corresponding resampling frequencies may be used, for instance 100 Hz, 300 Hz, 500 Hz, 1 kHz or even higher frequencies.

Typically, the original samples are combined with the new samples to form a augmented set of samples. However, some or all of the original samples may be ignored when forming the augmented set, in which case the original samples merely serve to determine the mathematical functions in step 1.

The interpolation step 1 and the resampling step 2 together constitute an “up sampling” step, resulting in an augmented set of samples having a higher, constant sampling frequency which allows filtering and, optionally, other processing steps.

In a filtering step 3 the signal is low-pass filtered. This filtering step preferably comprises the steps 31-35 illustrated in FIG. 1. The filtering step serves to remove any high-frequency noise and to remove any artifacts introduced by the resampling step. The inventors have found that hand movements have frequencies which typically do not exceed 10 Hz. By applying a low-pass filter having a cut-off frequency (typically the −3 dB frequency) of approximately 10 Hz, noise can be removed with substantially no degradation of the original gesture signal. Of course other cut-off frequencies can be used as well, and those skilled in the art will understand that there is a trade-off between noise suppression and signal distortion. The cut-off frequency could be as low as approximately 6 Hz and as high as approximately 14 Hz or higher, but a range from 8 to 12 Hz is preferred.

The filtering step 2 is preferably carried out with an IIR (Infinite Impulse Response) filters, that is particularly suitable for digitally filtering gesture signals, as discussed above. In a preferred embodiment, the recursive filter is applied twice, once forward and once backward. This results in a zero-phase filter, that is, a filter that does not introduce any phase distortions. As a result, any signal distortions will be eliminated.

The gesture signal produced by the method of FIG. 2 will consist of a set of samples having a constant and relatively high sampling frequency. Such a signal is suitable for further processing by, for example, a handwriting recognition device (not shown).

The embodiment schematically depicted in FIG. 3 is largely identical to the one shown in FIG. 2, except for the additional down sampling step 4. This additional step reduces the number of samples of the signal, thus reducing the amount of memory required for storing the signal and/or the amount of bandwidth required for transmitting the signal. The number of samples is reduced by, for example, selecting one out of every n samples, where n may be equal to 2, 3, 4, . . . , 8, 9, 10, . . . , 20, . . . , depending on the resampling frequency used in step 2 and the cut-off frequency used in step 3. When, for example, a resampling frequency of 200 Hz is used, n is preferably equal to 8 (a down sampling, rate of 8:1), resulting in a sampling frequency of 25 Hz. At a filter cut-off frequency of 10 Hz, all signal components will be below half the sampling frequency, that is below 12.5 Hz, and aliasing will be avoided. It will be understood that at a lower filter cut-off frequency, the sampling frequency resulting from the down sampling may be lower as well.

The initial sample selected during the down sampling step is chosen such that the number of samples in the down sampled set of samples is maximized, and that the timing error is approximately equal at both ends. This is shown in FIG. 5 where an exemplary set of six samples 10a-10f is shown. This set is down sampled at a rate of 3:1, which means that one out of three samples are selected. The obvious choice would be samples 10a and 10d, the first and the fourth sample, as indicated at X. However, this would lead to a “gap” at the end of the set, where the final two samples 10e and 10f are not selected. In the method of the present invention it is preferred to spread the selected samples over the set so as to minimize “gaps” at the beginning and/or the end of the set. Accordingly, samples 10b and 10e are selected, leaving one unselected sample at each end of the set. It will be apparent to those skilled in the art that the “gaps” at the begin and end-point of the gesture signals may cause the well known “missing end-point problem”, and should therefore be avoided if possible.

The embodiment schematically depicted in FIG. 4 is largely identical to the one shown in FIG. 3, except for the additional compression step 5. The compression step serves to further reduce the amount of data that has to be transmitted and/or stored. Various data compression techniques are known and many of those techniques can be applied to the handwritten signal samples produced in accordance with the present invention. Preferred techniques, however, are based upon differential coding, that is, producing a compressed sample that only contains information on the difference to a reference sample. The reference sample can be the previous sample or the first sample of the set. For example, when a particular sample has spatial co-ordinates x=223 and y=315, and the previous sample had spatial co-ordinates x=210 and y=301, then only the much smaller difference values Δx=13 and Δy=14 are transmitted. Alternatively, the signals could be compressed by means of entropy encoding which is a loss-less compression technique that uses a lower number of bits to encode data that occurs more frequently. These codes are typically stored in a code-book and may be constructed a-priory by using the statistics obtained from the gesture signals. As stated above, the compression step 5 is optional and may be omitted as desired.

An example of a gesture signal that is processed according to the method of the present invention is shown in FIGS. 6a-d. In FIG. 6a, original samples constitute a letter “a”. This letter, which may have been produced by a program reading the position of a mouse cursor on a graphics tablet, is unevenly and sparsely sampled at about 10 Hz. These samples are unsuitable for further processing with recognizers that are used for recognition of handwriting signals. Typically, these kind recognizers require evenly sampled signals having sampling rates well above 60 Hz. However, according to the present invention, these samples can be made suitable for further processing with such kind of recognizers. By applying the interpolation, resampling and filtering steps of the present invention the letter shown in FIG. 6b is obtained. As can be seen, the letter of FIG. 6b is very smooth but has preserved the cusp.

After down sampling the letter of FIG. 6b, the letter of FIG. 6c results which consist of only ten sample points. However, as these sample points are produced in accordance with the present invention, they contain all information of the original handwriting signal. As a result, the gesture signal can be reconstructed. The reconstructed signal preserves all features, including the cusp, as shown in FIG. 6d.

The exemplary system 20 shown in FIG. 7 comprises an input device 21, a pre-processing device 22 and a handwriting recognition device 23. The input device 21 shown is a computer having a screen 25, a keyboard 26 and a pointing device (mouse) 27. The pointing device 27 controls the movement of a cursor 28 on the screen 25. A user can “write” a letter on the screen using the pointing device 27. The computer takes samples of the handwriting signal, that is, produces a series of samples (x, y, t) having x and y co-ordinates related to cursor positions on the screen 25 and a time reference t which is the moment at which the particular screen position (x, y) was determined. Preferably, these samples (x, y, t) are equidistant in time, that is, are separated by equal time intervals. However, as discussed above, this may not always be the case as the operating system of the computer may delay taking a sample due to multitasking, resulting in an unevenly sampled signal. Also, the computer may not be able to sample the signal at a frequency higher than 10 Hz, resulting in a sparsely sampled signal. The present invention allows even such unevenly and/or sparsely sampled signals to be used for handwriting recognition purposes.

To this end, the present invention provides a pre-processing device 22 which is connected to the input device 21 and the handwriting recognition device 23. The pre-processing device may be a general purpose computer programmed to carry out the method of FIGS. 1-4. A suitable software program may for this purpose be transferred into the pre-processing device 22 from a data carrier, such as a CD or a floppy disc. Alternatively, the pre-processing device 22 may be integrated in the input device 21 if the device 21 is a computer, as in the example of FIG. 7, the computer 21 running a suitable software program for carrying out the method of the present invention.

The handwriting recognition device 23 may be a conventional handwriting recognition device, or a computer running conventional handwriting recognition software.

Instead of the computer 21 shown in FIG. 7 other input devices may be used in conjunction with the present invention, such as PDAs (Personal Digital Assistants), mobile telecommunications devices such as 3G mobile telephones, laptop and notebook computers, and other devices. Instead of a mouse, other pointing devices can be used, such as track balls, touch pads, etc. The present invention can also advantageously be used with touch screens.

The present invention is based upon the insight that even sparsely or unevenly sampled handwriting signals typically contain sufficient information to produce a signal, which is suitable for further processing. The present invention benefits from the further insight that handwriting motion signals are typically limited to frequencies not exceeding 10 Hz, which enables handwriting signals to be reconstructed even if the original samples are (on average) approximately 100 ms or even further apart.

It is noted that any terms used in this document should not be construed so as limit the scope of the present invention. In particular, the words “comprise(s)” and “comprising” are not meant to exclude any elements not specifically stated. Single (circuit) elements may be substituted with multiple (circuit) elements or with their equivalents. Any reference signs in the claims should of course not be construed so as to limit the scope of the claims.

It will be understood by those skilled in the art that the present invention is not limited to the embodiments illustrated above and that many modifications and additions may be made without departing from the scope of the invention as defined in the appending claims.

1. A method of processing a gesture signal comprising one or more segments, each segments comprising one or more samples, the method comprising the step of filtering one or more segments by applying an infinite impulse response filter both in a forward and in a backward temporal direction, so as to produce a band-limited gesture signal.

2. The method according to claim 1, wherein the infinite impulse response filter applied in the forward temporal direction has forward initial conditions and the infinite impulse response filter applied in the backward temporal direction has backward initial conditions, the method further comprising the step of matching the forward and backward initial conditions.

3. The method according to claim 1, further comprising the preliminary steps of:
interpolating the sampled signal, and
resampling the interpolated signal at a relatively high frequency,
so as to produce a gesture signal having a well-defined sampling rate which can then be appropriately filtered.

4. The method according to claim 3, wherein the step of interpolating the sampled signal involves a linear interpolation.

5. The method according to claim 1, further comprising the step of downsampling the filtered signal.

6. The method according to claim 1, further comprising the step of compressing the signal.

7. The method according to claim 6, wherein the step of compressing the signal involves differentiating and/or entropy encoding.

8. The method according claim 3, further comprising the step of recognizing handwriting on the basis of the interpolated, resampled and filtered signal.

9. A software program for carrying out the method according claim 1.

10. A data carrier comprising the software program according to claim 9.

11. A device for processing gesture signals, the device containing the software program according to claim 10.

12. A device for processing a gesture signal comprising one or more segments, each segments comprising one or more samples, the device comprising means for filtering one or more segments by applying an infinite impulse response filter both in a forward and in a backward temporal direction, so as to produce a band-limited gesture signal.

13. The device according to claim 12, wherein an infinite impulse response filter applied in a forward temporal direction has forward initial conditions and an infinite impulse response filter applied in a backward temporal direction has backward initial conditions, the device further comprising means for matching the forward and backward initial conditions.

14. The device according to claim 12, further comprising means for:
interpolating the sampled signal, and
resampling the interpolated signal at a relatively high frequency, prior to the filtering so as to produce a gesture signal having a well-defined sampling rate which can then be appropriately filtered.

15. The device according to claim 14, wherein the means for interpolating the sampled signal are arranged for a linear interpolation.

16. The device according to any of the claims 12 further comprising means for down sampling the filtered signal.

17. The device according to any of the claims 12 further comprising means for compressing the signal.

18. The device according to claim 17, wherein the means for compressing the signal are arranged for differentiating and/or entropy encoding.

19. The device according to any of the claims 13, further comprising means for recognizing handwriting on the basis of the interpolated, resampled and filtered signal.

20. A handwriting recognition system, comprising an input device for inputting handwriting signals and a recognition device for recognizing handwriting signals, the system further comprising a processing device according to claim 11.
